(19) United States
(12) Patent Application Publication
(10) Pub. No.: US 2026/0236852 A1
(43) Pub. Date: Aug. 13, 2026

(54) MULTI-GRAPH FRAMEWORK AND WEIGHTED VECTORIZATION APPROACH FOR CLASSIFIER MODEL TRAINING AND INFERENCE

(71) Applicant: Optum, Inc., Minnetonka, MN (US)

(72) Inventors: Hitesh KHARBANDA, Uttar Pradesh (IN); Sanjay K. DWIVEDI, Uttar Pradesh (IN)

(21) Appl. No.: 19/050,675

(22) Filed: Feb. 11, 2025

(51) Int. Cl. G06N 20/20; G06F 16/22; G06F 16/901

(52) U.S. Cl. CPC G06N 20/20; G06F 16/2237; G06F 16/9024

(57) ABSTRACT

Various embodiments of the present disclosure provide a graph-based vectorization process that improves the functionality of a computer in various aspects. The techniques comprise receiving a request that comprises entity identifier corresponding to a set of class value combinations, generating a class-specific graph representation of the entity identifier based on the set of class value combinations, generating a weighted class-specific graph representation from the class-specific graph representation, generating a class-specific vector representation for the entity identifier based on the weighted class-specific graph representation, inputting the class-specific vector representation to a machine learned classifier to receive a classification for the entity identifier, and then providing a response to the request based on the classification.

### BACKGROUND

In various domains, classification of entities based on complex relational data presents significant computational challenges. Such classifications are traditionally used to identify entities exhibiting particular characteristics and/or behaviors within large datasets. The efficacy of classification within a particular domain is limited by a computer's capability of processing and analyzing multi-dimensional relational data. Traditional machine learning classification approaches, for example, leverage semantic details within a dataset by converting data into representations that encode the semantic details of the original dataset. While such approaches excel with certain types of data, they may fail to capture intricate relationship patterns between features within complex datasets. This reduces the performance of machine learning models for predictive tasks.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram of an example graph-based vectorization framework for a classifier model in accordance with some embodiments of the present disclosure.

FIG. 5 depicts a dataflow diagram of an example machine learning inference and training approach in accordance with some embodiments of the present disclosure.

FIGS. 6A-B depict operational examples of a first and second stage of a weighting mechanism in accordance with some embodiments of the present disclosure.

FIG. 7 depicts an operational example of a graph vectorization approach in accordance with some embodiments of the present disclosure.

FIG. 8 depicts a flowchart diagram of an example graph-based vectorization and prediction process in accordance with some embodiments of the present disclosure.

### DETAILED DESCRIPTION

Various embodiments of the present disclosure provide graph-based feature engineering and vectorization techniques that improve the functionality of a computer with respect to machine learning training and inference. To do so, some embodiments of the present disclosure provide a multi-staged graph-based vectorization framework that combines graph analytics, embeddings, and weighting mechanisms into a single pipeline to generate improved feature vectors for machine learning models. For example, to overcome performance deficiencies of traditional machine learning models with respect to multi-dimensional, relational data, the multi-staged graph-based vectorization framework applies graph embedding techniques, with weighting mechanisms to address statistical variabilities, as an intermediate operation of a vectorization process. By doing so, the resulting feature vectors (e.g., class-specific vector representations, input vector representations and others described within this disclosure) of the vectorization process may encode both semantic (e.g., via embeddings) and relational (e.g., via the intermediate graph structures) information from a dataset. During training, the multi-staged graph-based vectorization framework may be applied to a training dataset to improve the performance of a machine learned model with respect to relational data. Thereafter, the multi-staged graph-based vectorization framework may be applied to input data to convert raw data into specialized vectors that bridge the traditional disconnections between multi-dimensional, relational data and traditional machine learning classifier architectures. In this manner, some of the techniques of the present disclosure may improve the performance (e.g., in terms of accuracy, generalizability) of machine learned models through the application of the multi-staged graph-based vectorization framework during training, inference, or both.

The multi-staged graph-based vectorization framework of the present disclosure may enable new stacked, machine learning architectures that may leverage the feature vectors of the multi-staged graph-based vectorization framework to train and subsequently use multiple instantiations of classifiers stacked within a single architecture and capture predictive insights across a set of different data dimensions. The stacked architecture, for example, may separate a single classifier into multiple classifiers each designed for a different combinations of classes (e.g., dimensions) within a dataset. The classes within a dataset may be defined to separate different predictive variables within a dataset into their own predictive units to allow a classifier to learn relationships between both the semantic and statistical characteristics of the predictive variable. These may comprise, for example, a geo-location class, diagnosis code class, provider specialty class, and/or the like for a clinical prediction use case, historical processing usage class, memory usage class, execution timing class, and/or the like for a network prediction use case, and/or the like. Traditional classifiers learn relationships between the features exhibited across all classes which limit their predictive performance. By leveraging the multi-staged graph-based vectorization framework of the present disclosure, these single classifier solutions may be expanded into stacked solutions that specialize each of set of classifiers to a subset of classes within a set of classes designed for the prediction domain.

To allow for the training and inference operations of the specialized classifiers within a stacked architecture, the predictive features exhibited by each class within the dataset may be expanded through a series of class feature engineering iterations in which class-specific vector representations may be created that each incorporate both the semantic and relational features of a respective class. The resulting class-specific vector representations may be arranged according to different model-specific vector structures (e.g., that combine vectors from a specific subset of classes in a particular arrangement) to create a set of different feature vectors (e.g., input vector representations) each reflective of different predictive dimensions within a dataset. By doing so, a set of different, stacked classifier layers within a single model architecture may be trained for a particular dimension of a dataset (e.g., as defined by a unique combination of defined feature classes) to expand the predictive performance (e.g., in terms of accuracy) of a machine learned model with respect to multi-dimensional prediction spaces in which a prediction may be derived from patterns within any of a set of defined feature classes. In this way, at inference (and/or during training), the multi-staged graph-based vectorization framework may be applied to an input dataset to convert the input dataset into a set of predictive feature vectors tailored to a set of specialized classifiers that may collaborate (e.g., using an aggregation layer, such as polling layer, voting layer) to generate a single prediction that accounts for varied dimensions within a large, multidimensional dataset.

By way of example, at inference, the multi-staged graph-based vectorization framework may convert a set of input data objects to a group of class value combination sets that respectively corresponds to a set of defined feature classes for a predictive task. A class value combination, for example, may distill a set of class value from an input data object that are specific to defined class. For example, an input data object that is associated with a geolocation and a set of clinical codes may be distilled into two class value combinations, a first comprising the geolocation and a second comprising the set of clinical codes. At up to each of the series of iterations, the multi-staged graph-based vectorization framework may convert a set of class value combinations first into a class-specific graph representation, then into a weighted class-specific graph representation, and finally into a single class-specific vector representation that consolidates the semantic and relational information from the input data objects and intermediate graph representations thereof into a single class-specific vector. The series of iterations may be performed to generate a class-specific vector for up to each of a set of defined feature classes. Thereafter, the resulting set of class-specific vectors may be concatenated, in accordance with different model-specific vector structures, to generate input vector representations that encode the semantic and relational information from the input data objects and intermediate graph representations thereof into a set of unique data dimensions tailored to a layer within a stacked classifier architecture. A series of input vector representations may be generated that respectively correspond to the series of layers within a stacked classifier architecture to expand one multi-dimensional dataset with multiple dimensions into a set of single dimensional vectors each tailored to one of the multiple dimensions. These vectors may then be respectively input to the set of specialized classifiers to generate a prediction with higher accuracy compared to traditional machine learning approaches.

In some cases, the conversion of data between graph and vector representations may introduce biases and/or other machine learning deficiencies by introducing predictive insights, such as relational data, which may inaccurately skew the initial dataset. To address such challenges, some techniques of the present disclosure provide a weighting mechanism that may be applied to a graph representation and vectorized representations thereof to capture and normalize the relative significance of different features (e.g., relational features, class values) extracted from an original input. The weighting mechanism, for example, may determine node weights and/or edge weights based on the statistical characteristics of an element within the graph to provide context for the structural aspects of a graph representation that may be encoded by downstream vectors. In this manner, some techniques of the present disclosure may integrate structural graph components with vectorization approaches without introducing bias into a training and/or inference process. This, in turn, leads to improved downstream machine learning training operations that may ultimately improve the accuracy of computers with respect to several machine learning tasks.

Examples of technologically advantageous embodiments of the present disclosure comprise a distribution of graph, vector, and weighing functionalities within a machine learning framework that improves machine learning training, machine learning inference, and data conversion, among other aspects of the present disclosure. Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

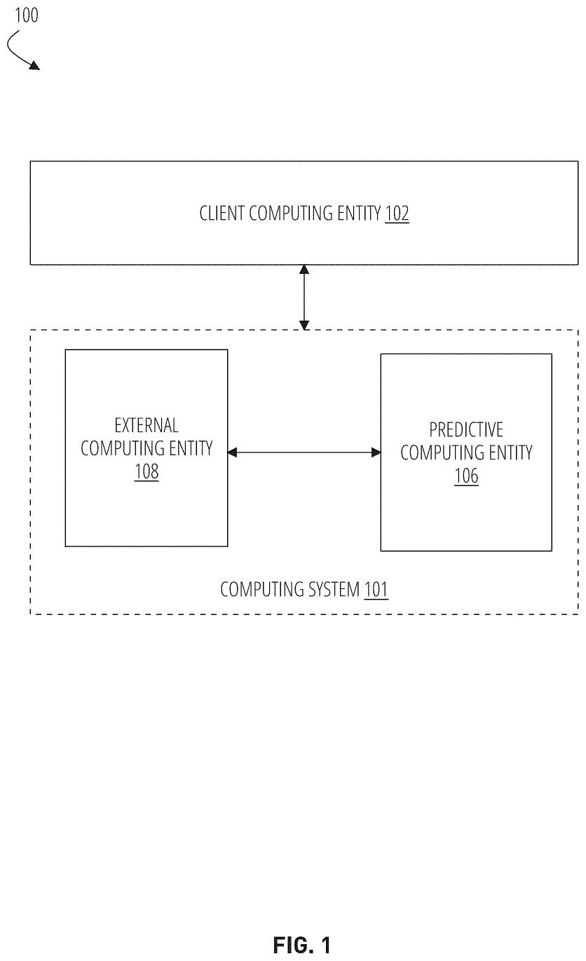

FIG. 1 depicts a block diagram of an example architecture 100 in accordance with some embodiments of the present disclosure. The architecture 100 comprises a computing system 101 configured to receive a request, such as an entity detection request, and/or the like, from client computing entities 102, process the request, and provide a response to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate machine learned outputs, such as binary classification outputs. The models may be adapted to a multi-staged graph-based vectorization framework that may collectively process a request using varied input vector representations of a dataset corresponding to the request. Some techniques of the present disclosure may adapt traditional models to a cohesive framework, such as the stacked model architecture, for more accurately handling portions of the request and/or associated input dataset.

In some embodiments, the computing system 101 may communicate with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., classification, training, inference, feature engineering techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as a set of input data objects, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

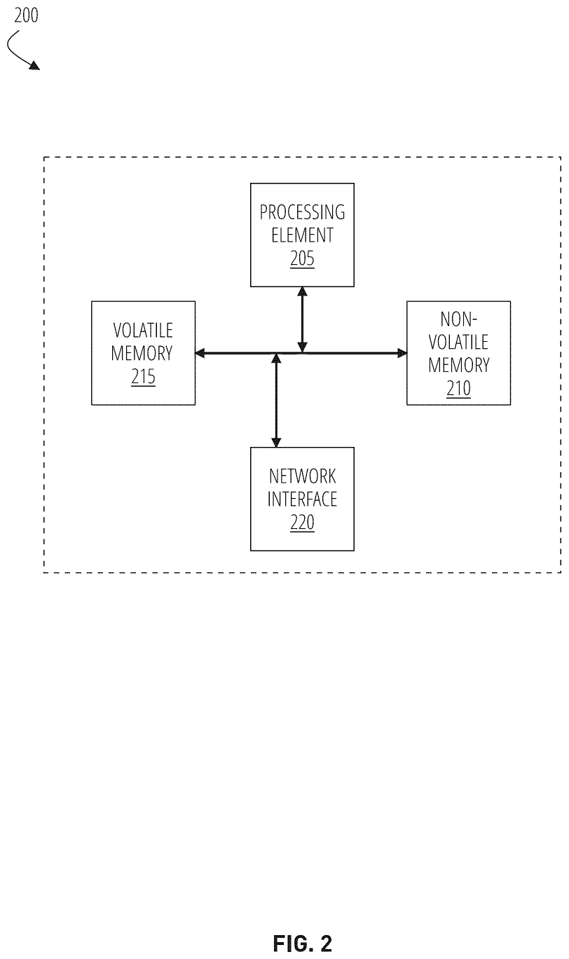

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably), volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (comprising various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilize quantum bits, or qubits, which may exist in multiple states simultaneously through a property called superposition. Unlike classical bits that may only be in a state of 0 or 1, qubits may represent both states at once, allowing for exponentially larger information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, comprising as computer program products that comprise articles of manufacture. Such computer program products may comprise one or more software components comprising, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (comprising volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more embodiments of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning task. By way of example, large language models (LLMs) and other transformer networks may be specially designed for operation within a quantum environment by replacing weight matrices in self-attention and/or multi-layer perceptron layers of such models with one or more combinations of two variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

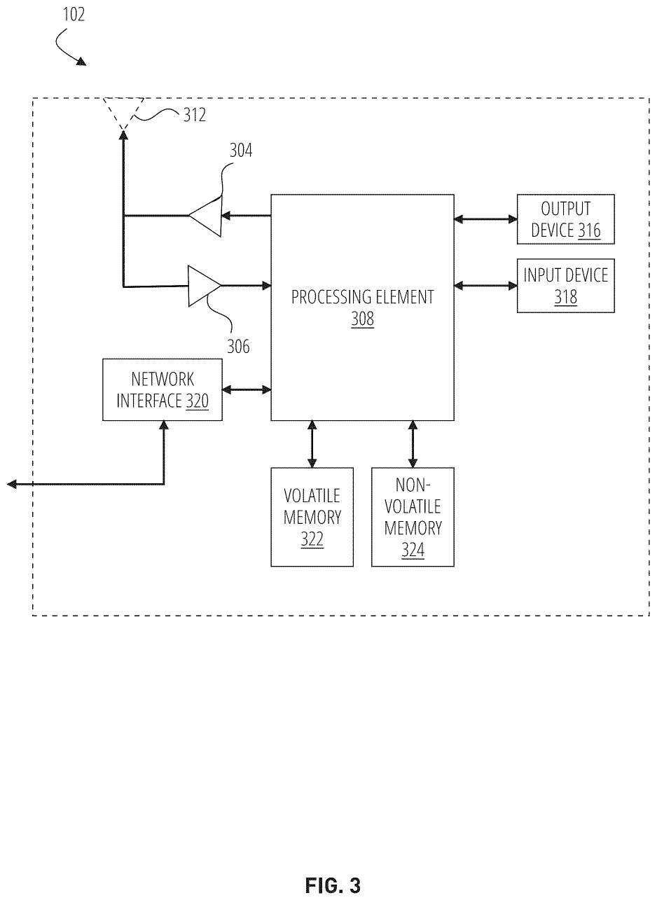

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., comprising executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, comprising Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, comprising cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to machine learning technology. In particular, systems and methods are disclosed herein that implement a graph-based vectorization framework for a classifier model to improve machine learning accuracy and generalizability to multi-dimensional, relational data. By doing so, the graph-based vectorization framework of the present disclosure enables improved machine learning processes that, when executed on a computer, improves the predictive capabilities of the computer with respect to various prediction tasks. This, in turn, may improve the functionality of a computer with respect to various computing tasks, including data security, machine learning training, resource allocations, entity detections, and the like.

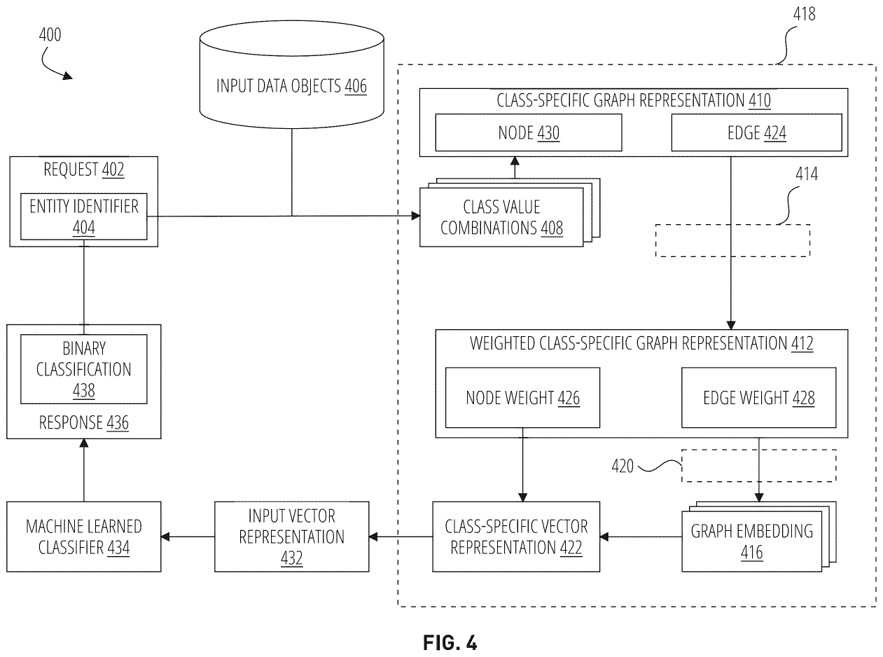

FIG. 4 depicts a dataflow diagram 400 of an example graph-based vectorization framework for a classifier model in accordance with some embodiments of the present disclosure. The graph-based vectorization framework may be implemented by a computing system, such as the computing system 101, to generate improved predictions for a request 402 through a series of class feature engineering iterations 418 for an entity identifier 404. Traditionally, the performance of machine learned classifiers, such as the machine learned classifier 434, is limited by the raw data available to train the model. In some cases, feature engineering is used to improve the predictive capacity of available raw data and, by doing so, improving the performance (e.g., in terms of accuracy) of machine learned classifiers. Using the graph-based vectorization framework, the computing system 101 may implement improved feature engineering techniques that address limitations in traditional frameworks by extracting and then encoding additional context and semantic relationships within training and input feature vector (e.g., labeled training vector representations, input vector representation 432) for a machine learned classifier 434. This is done, for example, through a series of class feature engineering iterations 418 that integrate graph, scaling, and vectorization techniques into a cohesive framework that transforms raw data into one or a set of input vector representations 432 for a machine learned classifier 434.

In some embodiments, the computing system 101 receives a request 402 that comprises entity identifier 404 corresponding to a set of class value combinations 408. In some examples, up to each of the set of class value combinations 408 respectively correspond to up to each of a set of input data objects 406 associated with the entity identifier 404. For example, the computing system 101 may extract a class value combination from up to each of the set of input data objects 406. In addition, or alternatively, a subset of the set of input data objects 406 may correspond to a member of a member cohort associated with the entity identifier 404. In some examples, the set of class value combinations 408 may respectively correspond to a set of members within the member cohort. By way of example, a class value combination may comprise a set of class values aggregated from up to each of the subset of input data objects for a particular member of the member cohort. In other words, a class value combination may comprise a set of class values that is aggregated from a single input data object associated with an entity identifier 404 (e.g., a one to one relationship between a class value combination and an input data object) or one or more input data objects associated with a member within a member cohort associated with the entity identifier 404 (e.g., a one to one relationship between a class value combination and a member).

In some embodiments, the request 402 is a communication provided to the computing system 101 to assess an entity identifier 404. The request 402, for example, may comprise an API call or other message format that is processed by one or more computer processors. The request 402 may comprise data that identifies a specific entity, such as the entity identifier 404, that is to be evaluated using the graph-based vectorization framework of the present disclosure. In some examples, the request 402 may be structured as a data object, data packet, and/or the like that comprises the entity identifier 404 and/or one or more additional parameters, such as a location parameter for a set of input data objects 406 for processing, a sender identifier, a recipient identifier, and/or the like. The request 402, for example, may be formatted according to a defined API specification and/or messaging protocol. When received by the computing system 101, the request 402 may trigger a series of computational steps to retrieve relevant data, generate graph representations, and apply machine learning models to process an entity corresponding to the entity identifier 404.

In some embodiments, the entity identifier 404 is a unique value that identifies a specific entity within a particular domain or use case. An entity identifier 404, for example, may comprise an alphanumeric string, numeric value, vector, and/or the like, that is stored in a database and/or other data structure. In some examples, the entity identifier 404 may comprise a unique key that may be leveraged to retrieve and associate relevant data for a given entity across multiple systems and/or datasets. For instance, the entity identifier 404 may comprise a primary key, enabling efficient indexing and lookup of entity-related information, such as the set of input data objects 406. By way of example, in a healthcare context, an entity identifier 404 may comprise a provider identifier that uniquely identifies a specific healthcare provider and may be used to aggregate medical claims issued, processed, and stored across a multiple systems and/or datasets. As another example, in a computer infrastructure context, an entity identifier 404 may comprise a computer identifier, such as a hardware identifier, device identifier, and/or machine fingerprint, that may be used to aggregate messages (e.g., activity monitoring reports, debug reports, performance metrics) issued, processed, and stored across a multiple systems and/or datasets.

In some embodiments, an input data object is a unit of information that is available for an entity identifier 404. An input data object, for example, may comprise a structured and/or unstructured collection of attributes associated with a target entity. Up to each input data object within a set of input data objects 406 may encapsulate relevant information about an entity for a particular predictive task in various forms, such as text, images, audio, and/or the like. In some examples, form, content, and/or structure of the input data object may depend on the prediction domain. For example, in a healthcare domain, an input data object may comprise a medical claim that may encapsulate healthcare information for a member of a healthcare provider in the form natural language and/or structured text, images, and/or the like. By way of example, an input data object may comprise details, such as clinical codes (e.g., International Classification of Diseases (ICD) codes, Current Procedural Terminology (CPT) codes), location data (e.g., location of a virtual or physical office visit, member address), specialty data (e.g., specialist categorizations), and/or the like, from a medical claim issued by the healthcare provider for a specific member. As another example, in a computer infrastructure domain, an input data object may comprise an activity monitoring report that may encapsulates activity information between one or more applications of a computer in the form natural language and/or structured text, images, and/or the like. By way of example, an input data object may comprise details, such as processing usage, memory usage, execution times, and/or the like, from an activity monitoring report for a computer.

In some embodiments, an input data object comprises one or more class values. A class value, for example, may comprise a data value for one of a set of defined feature classes of data types. For example, a class value may comprise a specific attribute value belonging to a particular defined feature class. A class value may comprise a concrete instance and/or occurrence of an attribute within a range (e.g., numerical range, categorical range) defined by its corresponding class. For example, in a clinical domain, a class value may comprise a specific procedure code within the procedure code class, a particular location within the geo-location class, a specific specialty within the provider specialty class, and/or the like. As another example, in a computer infrastructure domain, a class value may comprise a particular processing use within a processing usage class, a memory capacity in a memory usage class, a timestamp within an execution timing class, and/or the like.

A class value may be implemented as a data element that conforms to a structure and/or constraints defined by its class. This may be a primitive data type (e.g., a string, such a categorical tag, an integer, probabilistic value), a complex object, a reference to another data entity, and/or the like, depending on the nature of its defined feature class. In some examples, class values may be reflected within an input data object as structure data, or unstructured text, numerical values, images, audio, and/or any other data format. In the case of unstructured data, the computing system 101 may extract the class values (e.g., using natural language processing, image extraction) from an input data object and store the class values in a data format corresponding to their defined feature classes.

In some embodiments, the defined feature class is a type of attribute that is defined for a particular prediction task. A defined feature class, for example, may comprise a specific type and/or category of information that may provide predictive insights for a classification task. A set of defined feature classes may be domain specific. For example, in a healthcare domain, a set of defined feature classes may comprise a geo-location class, a procedure code class, a diagnosis code class, a provider specialty class, and/or the like. As another example, in a computer infrastructure domain, a set of defined feature classes may comprise a processing usage class, a memory usage class, an execution timing class, and/or the like.

In some examples, a defined feature class may define a data type, schema definition, and/or the like that specifies the structure and/or constraints for a particular category of attributes. This may be realized through class definitions in object-oriented programming languages, custom data types in database systems, schema specifications in data serialization formats, and/or the like. In some embodiments of the present disclosure, a set of defined feature classes may be defined to capture different verticals of information for a prediction task. In this way, the set of defined feature classes may enable a creation of separate graph representations, embeddings, feature vectors, and/or the like for different attribute categories. This separation allows for more nuanced analysis and the application of specialized processing techniques tailored to each attribute type. Moreover, the use of defined feature classes may enhance the flexibility and/or extensibility of the prediction task by enabling the incorporation of new attribute types by defining additional classes, without requiring changes to the core processing logic.

In some embodiments, a class value combination is a set of class values that co-occur within a particular context, such as a single input data object, a group of related objects associated with a single member, and/or the like. A class value combination may comprise any data structure that groups related class values together, such as an array, set, custom object that maintains the association between the combined values, and/or the like. In database systems, class value combinations may be represented through join operations, denormalized data structures optimized for efficient querying, and/or the like.

A class value combination may be specific to a defined feature class of the set of defined feature classes. For example, a class value combination may comprise a set of class values of a particular defined feature class and that co-occur within a particular context. In this way, a class value combination may capture the simultaneous presence of multiple attribute values within a particular context. For example, in a healthcare domain, a set of defined feature classes may comprise a geo-location class, a procedure code class, a diagnosis code class, a provider specialty class, and/or the like. As another example, in a computer infrastructure domain, a set of defined feature classes may comprise a processing usage class, a memory usage class, an execution timing class, and/or the like. In any domain, a class value combination may capture the relationships through co-occurrence patterns among different attributes within a particular class. In this way, the set of class value combinations 408 may form a basis for generating class-specific graph representations 410 to identify meaningful associations and derive complex features that go beyond individual attribute values as described herein.

In some examples, the computing system 101 may extract a group of class value combinations from an input data object of the set of input data objects 406. The group of class value combinations, for example, may respectively correspond to a set of defined feature classes. For example, a class value combination may comprise a first class value combination of the group of class value combinations that corresponds to a first feature class of the set of defined feature classes, a second class value combination of the group of class value combinations that corresponds to a second feature class of the set of defined feature classes, and/or the like. In some examples, the group of class value combinations may be individually (e.g., in parallel, sequentially) processed during a set of class feature engineering iterations 418 at a class level to create class specific data structures tailored to up to each of the defined feature classes at each class feature engineering iteration 418.

In some embodiments, the computing system 101 generating a class-specific graph representation 410 of the entity identifier 404 based on the set of class value combinations 408. To do so, the computing system 101 may generate a first node corresponding to a first class value of a class value combination of the set of class value combinations 408, generate a second node corresponding to a second class value of the class value combination, and responsive to the presence of the first class value and the second class value within the class value combination, generate an edge between the first node and the second node. More generally, the computing system 101 may generate a node for up to each unique class value within the set of class value combinations 408. In addition, or alternatively, the computing system 101 may generate an edge connecting a node pair for up to each pair of class values within the set of class value combinations 408. A pair of class values, for example, may comprise two different class values that are located within a single class value combination.

In some embodiments, the class-specific graph representation 410 is a graph data structure that encodes relationships between class values within a specific defined feature class for a given entity. For example, the class-specific graph representation 410 may capture co-occurrence patterns and/or other associations among class values of a defined feature class. To do so, up to each of a set of class-specific graph representations may comprise a set of class-specific nodes 430 that correspond to a particular defined feature class. For example, in a healthcare domain, a set of class-specific graph representations may comprise a geo-location graph with nodes 430 representing individual geographic locations, a procedure code graph with nodes 430 representing individual procedure codes, a diagnosis code graph with nodes 430 representing individual diagnosis codes, a provider specialty graph with nodes 430 representing individual provider specialties, and/or the like. As another example, in a computer infrastructure domain, a set of class-specific graph representations may comprise a processing usage graph with nodes 430 representing individual processing rates, a memory usage graph with nodes 430 representing individual memory capacities, an execution timing graph with nodes 430 representing individual execution timestamps, and/or the like.

The class-specific graph representations 410 may be implemented as a data structure that encodes nodes 430 (e.g., class values) and edges 424 (e.g., co-occurrence relationships) in a format suitable for graph processing algorithms. By way of example, the class-specific graph representations 410 may comprise an adjacency list, adjacency matrix, specialized graph database, and/or the like.

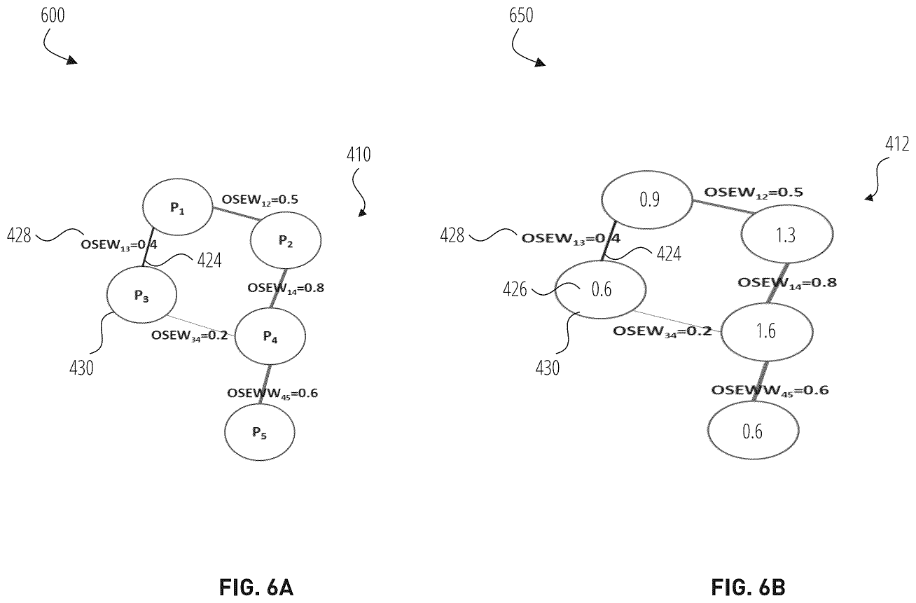

The computing system 101 may generate the class-specific graph representation 410 based on the set of class value combinations 408 for a particular defined feature class. For example, the computing system 101 may generate a node 430 for up to each unique class value within the set of class value combinations. A node 430, for example, may comprise a vertex within a class-specific graph representation 410 that corresponds to a particular class value. Up to each node of a set of nodes 430 within the class-specific graph representation 410 may comprise a data object and/or structure that may comprise one or more properties, such as a unique identifier, the class value it represents, and/or additional metadata relevant to the prediction task. In some examples, as described with reference to FIG. 6A, up to each node of the set of nodes 430 may be assigned a node weight 426 that may be stored as an additional property within the node data structure.

In addition, or alternatively, the computing system 101 may generate an edge 424 for up to each unique combination of class values within the set of class value combinations 408. For example, an edge 424 may be formed based on the co-occurrence of two class values within a single class value combination. An edge 424, for example, may comprise a link within a class-specific graph representation that connects two nodes, representing the co-occurrence and/or relationship between two class values. For example, an edge 424 may indicate that the connected class values appear together within a single class value combination, such as within the same input data object or across related input data objects for a particular member associated with the entity. Up to each edge of a set of edges 424 within the class-specific graph representation 410 may comprise a data structure that defines a connection between two nodes in a class-specific graph representation 410. The data structure may comprise one or more edge properties, such as one or more references to the connected nodes and/or additional properties describing a nature of the relationship between the connected nodes. In some examples, as described herein with reference to FIG. 6B, up to each edge of the set of edges 424 may be assigned an edge weight 428 that may be stored as an additional property within the edge data structure.

In some examples, through the set of class feature engineering iterations 418, the computing system 101 may generate, based on the group of class value combinations of up to each of the set of input data objects 406, a set of class-specific graph representations 410 that respectively correspond to the set of defined feature classes. For example, the class-specific graph representation 410 may comprise a first class-specific graph representation of the set of class-specific graph representations that corresponds to the first feature class, a second class-specific graph representation of the set of class-specific graph representations that corresponds to the second feature class, and/or the like.

In some embodiments, the computing system 101 generates a weighted class-specific graph representation 412 from the class-specific graph representation 410 by assigning an edge weight 428 to the edge 424 based on a relative combination frequency of the first class value and the second class value within the set of class value combinations 408. In addition, or alternatively, the computing system 101 may assign a node weight 426 to up to each node based on the edge weight 428. The node weight 426, for example, may comprise an aggregation of a subset of edge weights, from a set of edge weights of the weighted class-specific graph representation 412, that is associated with a subset of edges, from a set of edges 424 of the weighted class-specific graph representation 412, connected to a particular node 430.

In some embodiments, the weighted class-specific graph representation 412 is an enhanced version of a class-specific graph representation 410 that is weighted to express influential relationships with the class-specific graph representation 410. For example, the weighted class-specific graph representation 412 may comprise weighted graph data structure with a set of edges 424, a set of nodes 430, a set of node weights 426 respectively corresponding to the set of nodes 430, and/or a set of edge weights 428 respectively corresponding to the set of edges 424. In some examples, the computing system 101 may apply a weighting mechanism 414 to the class-specific graph representation 410 to generate the weighted class-specific graph representation 412 by assigning a set of numerical weights (e.g., node weights 426, edge weights 428) to the nodes 430 and/or edges 424 of the class-specific graph representation 410 to reflect their relative importance, strength of association, and/or the like. In this way, the weighting mechanism 414 may transform the class-specific graph representation 410 into a weighted structure that provides a more nuanced representation of the relationships among class values, allowing for more sophisticated analysis and feature extraction.

The weighting mechanism 414 may comprise a set of weighting functions (e.g., computer executable instruction sets) that may be applied to the nodes 430 and/or edges 424 of the class-specific graph representation 410 to generate node weights 426 and/or edge weight 428 in accordance with weighting criteria defined for a particular predictive task.

For example, via a first node-weighting function of the weighting mechanism 414, the computing system 101 may determine an edge weight 428 for an edge 424 of the class-specific graph representation 410 based on a function of the co-occurrence patterns of the connected class values. The edge weight 428, for example, may be determined based on a ratio of (i) a co-occurrence of two class values within a set of class value combinations (and/or input data objects thereof) to (ii) a total occurrence of either of the class values within the set of class value combinations (and/or input data objects thereof). The total occurrence of either of the class values, for example, may comprise a total number of the set of class value combinations that comprise a first class value, a second class value, or both class values.

As another example, via a second edge-weighting function of the weighting mechanism 414, the computing system 101 may determine a node weight 426 for a node 430 of the class-specific graph representation 410 based on a function of the edge weights 428 of the edges connected to the node 430. The node weight 426, for example, may be determined for a particular node 430 based on an aggregated value (e.g., a sum, multiplication, mean) of a subset of the set of edge weights within the weighted class-specific graph representation 412 that correspond to a subset of edges connected to the particular node 430.

In some examples, through the set of class feature engineering iterations 418, the computing system 101 may generate, based on the group of class value combinations 408 of up to each of the set of input data objects 406, a set of weighted class-specific graph representations 412 that respectively correspond to the set of defined feature classes. For example, the weighted class-specific graph representation 412 may comprise a first weighted class-specific graph representation of the set of weighted class-specific graph representations that corresponds to the first feature class, a second weighted class-specific graph representation of the set of weighted class-specific graph representations that corresponds to the second feature class, and/or the like.

In some embodiments, the computing system 101 generates, using a graph model 420, a set of graph embedding 416 from the weighted class-specific graph representation 412. In some examples, the set of graph embedding 416 may comprise a graph embedding for up to each of set of nodes 430 of the weighted class-specific graph representation 412. For instance, the computing system 101 may generate a first graph embedding for the first node, a second graph embedding for a second node, and/or the like.

In some embodiments, the graph embedding 416 is a fixed-size vector, in a continuous vector space, of a node 430 within the weighted class-specific graph representation 412 that encodes the node attributes. For example, the graph embedding 416 may comprise a node-level embedding of a weighted class-specific graph representation 412, which captures the structural and/or relational information of the graph in a format suitable for downstream processes, such as the machine learning models of the present disclosure. In some examples, the computing system 101 may generate, using a graph model 420, a graph embedding 416 for up to each node 430 of the weighted class-specific graph representation 412. In this manner, the computing system 101 may convert a weighted class-specific graph representation 412 into a set of vectors that capture the relational information of the graph. In this way, the set of graph embeddings may serve as a bridge between the graph-structured data and machine learning models that operate on fixed-size vector inputs and enable the application of a wide range of machine learning techniques to graph-based problems, such as node classification, link prediction, graph classification, and/or the like. By capturing complex network structures in a vector space, graph embeddings 416 allow for efficient similarity computations and may reveal latent relationships obfuscated in the original graph structure.

In some embodiments, the graph model 420 is a machine learning and/or rule-based technique designed to convert graph-structured data into a set of vectors. For instance, the graph model 420 may comprise an instruction set for generating vector representations (e.g., graph embeddings) of nodes within a graph, enabling the conversion of graph-structured information into a format suitable for downstream computer applications, such as machine learning models. The graph model 420 may comprise a computational algorithm and/or neural network architecture specifically designed to operate on graph data structures. By way of example, the graph model 420 may comprise a graph neural network (GNN), graph convolutional networks (GCNs), graph attention networks (GATs), random walk-based approaches, such as DeepWalk, node2vec, and/or the like. In the case of neural network architectures, the graph model 420 may be trained, using semi-supervised and/or unsupervised training techniques, based on a reconstruction loss function designed to learn relationships between nodes, edges, and/or other features of the graph.

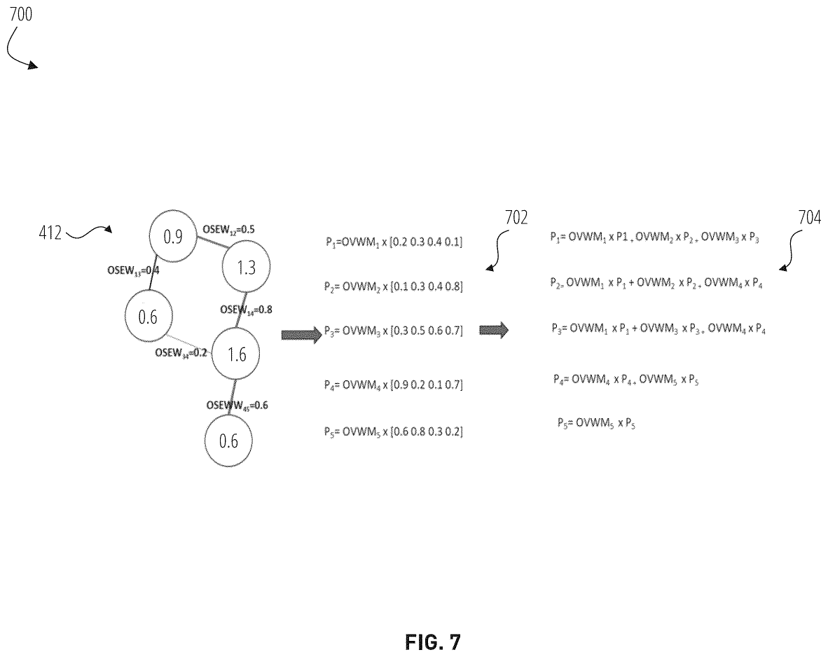

In some embodiments, the computing system 101 generates a class-specific vector representation 422 for the entity identifier based on the weighted class-specific graph representation 412 and/or the graph embedding 416 thereof. For example, the computing system 101 may generate the class-specific vector representation from the graph embeddings 416 and/or one or more derivatives thereof. For instance, as described with reference to FIG. 7, the computing system 101 may convert the graph embeddings 416 into a single the class-specific vector representation 422 through a series of graph vectorization operations to form an individual feature vector (and/or component thereof) for a downstream process.

In some embodiments, the class-specific vector representation 422 is a vector representation of a set of class value combinations 408 for a particular defined feature class. Using some of the techniques of the present disclosure, the class-specific vector representation 422 may be generated from a class-specific graph representation 410 such that encodes both the class values and the relationships therebetween, as modeled within the intermediate graph data structures. In this manner, at each class feature engineering iterations 418 of the graph-based vectorization framework, the computing system 101 may generate a robust vector representation for a particular class value predictive of a predictive task the encodes both semantic and relational information that may be used by downstream processes and/or models (e.g., e.g., machine learned classifier 434) to improve their performance. For example, the class-specific vector representations 422 generated at each class feature engineering iterations 418 may bridge the gap between the graph-structured data specific to a particular defined feature class and the fixed-size input requirements of machine learning models. By encoding a graph into a single vector, they enable the application of a wide range of traditional machine learning techniques to graph-based classification problems. These representations capture both the individual characteristics of nodes (e.g., class values) and the overall structure and patterns within the class-specific graph to provide a more predictive input for both training and inference operations of a downstream machine learning model.

In some examples, the class-specific vector representation 422 is a fixed-size vector that encodes the information within a graph data structure to a numerical format. In some examples, the class-specific vector representation 422 is derived from the graph embeddings 416 of the weighted class-specific graph representation 412. For instance, the class-specific vector representation 422 may comprise an aggregated and scaled vector representation from the weighted class-specific graph representation 412. In some examples, as described with reference to FIG. 7, the class-specific vector representation 422 may comprise an aggregation of enriched graph embeddings for up to each node 430 within the weighted class-specific graph representation 412. An enriched graph embedding for a particular node 430, for example, may comprise a graph embedding 416 that may be scaled using its node weight 426 (e.g., to generate an intermediate scaled graph embedding) and aggregated with a subset of scaled graph embeddings that respectively correspond to a subset of nodes connected to the particular node 430 (e.g., to incorporate local neighborhood information). By combining enriched graph embeddings for up to each node of a weighted class-specific graph representation 412, the class-specific vector representation 422 may provide a comprehensive vector encoding of the graph structure and node characteristics for a particular defined class. In some examples, the enriched graph embeddings may be combined using an aggregation function, which may comprise an element-wise summation, averaging, max pooling, attention-weighted summation, and/or the like.

In some examples, through the set of class feature engineering iterations 418, the computing system 101 may generate, based on the set of weighted class-specific graph representations, a set of class-specific vector representations that respectively correspond to the set of defined feature classes. The class-specific vector representation 422, for example, may comprise a first class-specific vector representation of the set of class-specific vector representations that corresponds to the first feature class, a second class-specific vector representation of the set of class-specific vector representations that corresponds to the second feature class, and/or the like.

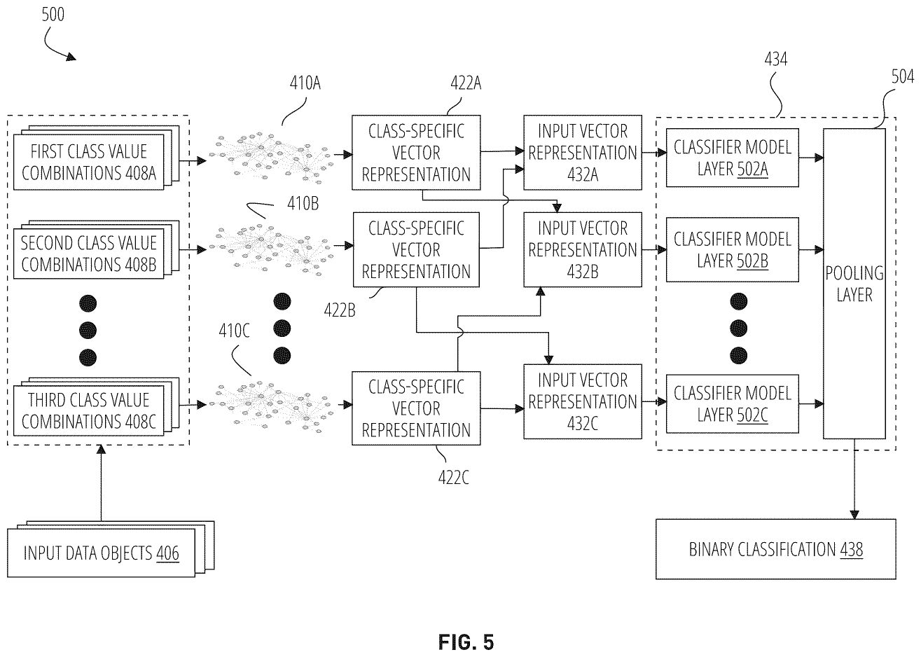

In some embodiments, the computing system 101 inputs the class-specific vector representation 422 (and/or a derivative thereof) and/or the set of class-specific graph representations (e.g., and/or derivatives thereof) to a machine learned classifier 434 to receive a binary classification 438 for the entity identifier 404. In some examples, as described with reference to FIG. 5, the computing system 101 may concatenate the class-specific vector representation 422 with one or more class-specific vector representations of a set of class-specific vector representations respectively corresponding to a set of defined feature classes to generate an input vector representation 432 for the machine learned classifier 434. For example, the class-specific vector representation 422 may be generated through a first iteration of a set of class feature engineering iterations 418. The computing system 101 may repeat an iteration of the set of class feature engineering iterations 418 for up to each of the set of defined feature classes to generate a class-specific vector representation for up to each of the set of defined feature classes. In such a case, the computing system 101 may generate one or more input vector representations 432 and input the input vector representations 432 to the machine learned classifier 434 to receive the binary classification 438.

In some embodiments, the machine learned classifier 434 is a computational model trained to generate a classification score, decision, and/or the like for a particular task based on an input vector representation 432. The machine learned classifier 434 may comprise a machine learning model of any model architecture, including supervised learning architectures (e.g., logistic regression, naive bayes classifier, decision tree, support vector machine, neural network), unsupervised learning architectures (e.g., k-means, Bayesian network), reinforcement learning architectures, semi-supervised learning architectures, and/or the like. By way of example, the machine learned classifier 434 may comprise a neural network and/or other machine learning model that is trained to produce a binary classification 438 (e.g., suspicious vs. genuine) from one or a set of input vector representations 432 for an entity identifier 404.

In some embodiments, the binary classification 438 is an output of the machine learned classifier 434 that identifies one of two distinct classifications for an entity identifier 404. The classifications, for example, may be designed for a particular predictive task. For instance, in a healthcare use case, the classifications may comprise a genuine and/or suspicious healthcare provider classification designed to detect suspicion healthcare providers in a healthcare fraud detection system. As another example, in a computer infrastructure use case, the classifications may comprise a replace or keep classification designed to proactively replace computer hardware before it reached the end of its lifespan. Any classifications may be defined to modify the techniques of the present disclosure for a particular predictive task. In any case, the binary classification 438 may comprise a binary value (e.g., 0 or 1), continuous value (e.g., between 0 and 1), a pairs of values (e.g., probabilities or scores for both classes, summing to 1), and/or the like that describes a prediction between two mutually exclusive outcomes. In some case, the techniques of the present disclosure may be extended to other outputs, such as multi-classification outputs, and/or the like.

In some embodiments, the computing system 101 provides a response 436 to the request 402 based on the binary classification 438. The response 436, for example, may comprise an output message (e.g., an API response) generated by the computing system 101 in reply to request 402. The response 436 may serve as the interface between the computing system 101 and/or an external application, user, and/or the like, that provides actionable information for an entity identifier 404. In some examples, the response 436 may comprise a structured data object (e.g., JSON object, XML message), message, and/or the like that encapsulates a binary classification 438 and/or relevant metadata for an entity identifier 404. The response 436, for example, may comprise fields, such as the entity identifier 404, the binary classification 438, (e.g., suspicious, genuine, replace, keep), and/or additional information, such as confidence scores, explanatory factors (e.g., a relative predictiveness of class values), and/or the like.

In some examples, the response 436 may enable downstream systems and/or processes to take action based on the classification results. For example, in a healthcare fraud detection system, a response 436 indicating a suspicious classification for a provider may trigger further investigation and/or automated monitoring processes. In a computer infrastructure example, the response 436 may trigger a computer replacement, security mitigation actions to lock a computing device, and/or the like. The structure and/or content of the response 436 may be designed to facilitate easy integration with these downstream systems by comprising additional context and/or metadata to support decision-making processes.

FIG. 5 depicts a dataflow diagram 500 of an example machine learning inference and training approach in accordance with some embodiments of the present disclosure. The machine learning inference and training approach may be implemented by a computing system, such as the computing system 101, to train and subsequently use an improved machine learned classifier 434 with a stacked architecture. The stacked architecture, for example, may be enabled by the feature engineering techniques discussed with respect to FIG. 4 by creating a set of contextually and semantically rich, class-specific vector representations 422A-C. Using the machine learning inference and training approach, the computing system 101 may aggregate different combinations of the class-specific graph representations 422A-C into input vector representations 432A-C that may be individually predictive of a binary classification 438. By doing so, the computing system 101 may train multiple, stacked classifier model layers 502A-C up to each of which may be trained on a different input vector representation (e.g., a particular arrangement of a subset of the class-specific graph representations 422A-C). As described herein, the machine learned classifier 434 may individually train up to each of the classifier model layers 502A-C and, during inference, pool the predictions of up to each of the trained classifier model layers 502A-C using a pooling layer 504 to generate a final prediction. This, in turn, enables improved predictions (e.g., in terms of accuracy, precision, recall) that leverage predictive insights from multiple different contextually relevant viewpoints to accommodate for the nuances of complex prediction domains, such as those for detecting malicious behavior (e.g., computer viruses, fraudulent personas) that is intended to be hidden from traditionally available input data.

As described with reference to FIG. 4, in some embodiments, the computing system 101 extracts a group of class value combinations from a set of input data objects 406 that comprises class value combinations 408A-C for up to each class of a set of defined feature classes. Through a series of class feature engineering iterations 418, the computing system 101 may convert the class value combinations 408A-C into class-specific graph representations 410A-C, and from class-specific graph representations 410A-C to class-specific vector representations 422A-C.

In some embodiments, the computing system 101 generates an input vector representation and/or a set of input vector representations 432A-C for the entity identifier up to each of which may comprise a different subset (and/or arrangement thereof) of the set of class-specific vector representations 422A-C that respectively correspond to a subset of the set of defined feature classes. By way of example, a first input vector representation 432A may comprise a subset of class-specific vector representations that comprises the first class-specific vector representation 422A and the second class-specific vector representation 422B, a second input vector representation 432B may comprise a subset of class-specific vector representations that comprises the first class-specific vector representation 422A and the third class-specific vector representation 422C, a third input vector representation 432C may comprise a subset of class-specific vector representations that comprises the second class-specific vector representation 422B and the third class-specific vector representation 422C, and/or the like.

In some examples, the subset of the class-specific vector representations 422A-C may be combined (e.g., concatenated) in accordance with a model-specific vector structure to form an input vector representation 432 of a set of input vector representations 432A-C. For example, an input vector representation 432 may comprise a combination of one or more of the class-specific vector representations 422A-C that serves as a feature vector input for a classifier model layer of a stacked classifier model architecture. Up to each of the set of input vector representations 432A-C may comprise a unique combination of the class-specific graph representations 422A-C to form multiple, partially overlapping vector sequences for a predictive task. In this way, a set of input vector representations 432 may be leveraged to implement a machine learned classifier 434 with a stacked architecture defining a set of classifier model layers 502A-C, up to each configured for a separate type of input vector representation 432.

For example, up to each of the input vector representations 432A-C may comprise a fixed-size vector that concatenates and/or otherwise combines one or more of the class-specific vector representations 422A-C. The computing system 101 may generate an input vector representation 432 by receiving the class-specific vector representations 422A-C for up to each of the set of defined feature classes, determining a subset of the set of class-specific vector representation 422A-C in accordance with a model-specific vector structure that corresponds to a particular classifier model layer of the machine learned classifier 434, and combining the determined subset of class-specific graph representations into a single vector (e.g., through concatenation).

In some embodiments, the model-specific vector structure comprises a template, schema, and/or the like that defines an arrangement, organization, structure, and/or the like of a subset of class-specific vector representations for a classifier model layer of the machine learned classifier 434. The model-specific vector structure, for example, may define an order of concatenation, defining sections within the vector for different class-specific vector representations 422, and/or the like. By way of example, a first classifier model layer 502A of the set of classifier model layers 502A-C may be associated with a first model-specific vector structure that defines an arrangement of the first class-specific vector representation 422A and/or the second class-specific vector representation 422B, a second classifier model layer 502B of the set of classifier model layers 502A-C may be associated with a second model-specific vector structure that defines an arrangement of the first class-specific vector representation 422A and/or the third class-specific vector representation 422C, a third classifier model layer 502C of the set of classifier model layers 502A-C may be associated with a third model-specific vector structure that defines an arrangement of the second class-specific vector representation 422B and/or the third class-specific vector representation 422C, and/or the like. In this manner, a set of model-specific vector structures may define different arrangements of the set of class-specific vector representations 422A-C that may be leveraged, during training, to configure a set of classifier model layers 502A-C for different aspects of a predictive task. During inference, by aligning the structure of an input vector representation 432 with the structure of labeled training vector representations used during training for a particular classifier model layer, the computing system 101 may enhance the model's performance (e.g., in terms of accuracy) with respect to a particular aspect of the predictive process. By doing so, the model-specific vector structures allow different portions of a stacked model architecture to focus (e.g., specialize) on different patterns exhibited by different portions of a complex input.

In some embodiments, the computing system 101 inputs the set of input vector representations 432A-C to the machine learned classifier 434. For instance, the set of input vector representations 432A-C may be input as a single feature vector to the machine learned classifier 434 and/or input as individual feature vectors to up each classifier model layer 502A-C of the machine learned classifier 434.

In some embodiments, the machine learned classifier 434 comprises a stacked model architecture, ensemble classifier, and/or the like, with a set of classifier model layers 502A-C connected to a pooling layer 504. In some examples, up to each of the classifier model layers 502A-C of the set of classifier model layers 502A-C may be individually trained using a set of labeled training vector representations. In addition, or alternatively, the pooling layer 504 may comprise a rule-based layer and/or a meta-model layer configured to pool the outputs from up to each of the classifier model layers 502A-C to generate the binary classification 438. In some examples, the pooling layer 504 may comprise a max voting layer.

In some embodiments, the classifier model layer 502 is an individual classification layer within a stacked (and/or ensemble) machine learning architecture that is specialized for processing a specific type of input vector representation 432. Up to each of the classifier model layers 502A-C may comprise distinct classification models, sub-models, and/or the like, that are trained to make predictions based on a particular feature vector. In some examples, up to each of the classifier model layers 502A-C may comprise separate machine learning models, each with its own architecture, parameters, and/or the like. Up to each layer, for example, may comprise one or more neural network layers implemented in a deep learning framework, decision trees, random forest, and/or the like. Up to each layer may be designed to take as input a specific type of input vector representation 432 and output an intermediary binary classification (e.g., a binary classification, classification score, classification probability, confidence score). In this way, the classifier model layers 502A-C may capture different aspects, views, and/or the like of an entity identifier and/or set of input data objects 406 corresponding thereto. By specializing in different types of input vector representations 432A-C, the classifier model layers 502A-C may individually focus on extracting relevant patterns from specific subsets of the available data. This specialization allows a machine learned classifier 434 with a stacked architecture to leverage a diverse set of perspectives, leading to more robust and accurate overall classifications.

In some embodiments, the pooling layer 504 is an aggregation layer within a stacked model architecture that combines individual outputs from multiple classifier model layers 502A-C into a single prediction. By doing so, the pooling layer 504 may enable the integration of diverse predictions to produce a unified output. In some examples, the pooling layer 504 may comprise a predefined aggregation methods, such as max voting, where the final classification is determined by a most frequent prediction among the individual classifier model layers 502A-C, weighted averaging, majority voting, and/or the like. In addition, or alternatively, the pooling layer 504 may be trained separately and/or jointly with the classifier model layers 502A-C, allowing it to learn optimal aggregation strategies based on the specific characteristics of the input data and the performance of individual classifiers of the machine learned classifier 434.

In some embodiments, the computing system 101 trains the machine learned classifier 434, using supervisory training techniques, based on a set of labeled training vector representations. In some examples, a labeled training vector representation of the set of labeled training vector representations may comprise (a) a negative label and/or a positive label and/or (b) a training vector representation that corresponds to a subset of the set of defined feature classes. For example, the computing system 101 may individually (and/or at least partially jointly) train up to each of the classifier model layers 502A-C using a set of labeled training vector representations that may be configured in accordance with a model-specific vector structure for the classifier model layer. For example, the computing system 101 may determine a set of labeled training vector representations using the techniques of the present disclosure for a set of labeled entity identifiers to generate a plurality of training entries. In some examples, the set of labeled entity identifiers may comprise a set of positively labeled entity identifiers (e.g., suspicious providers, degraded computing devices) and/or a set of negatively labeled entity identifiers (e.g., genuine providers, healthy computing devices). The computing system 101 may generate a set of positive training entries and/or a set of negative training entries to form the plurality of training entries. In some examples, the computing system 101 may train up to each of the classifier model layers 502A-C, using a model-specific training dataset (e.g., each comprise a set of positive and negative training entries), via backpropagation of errors using gradient descent to minimize a loss function, such a squared error, binary cross-entropy loss, hinge loss, mean squared error (e.g., for regression architectures), and/or the like.

FIG. 6A depicts an operational example 600 of a first stage of the weighting mechanism 414 in accordance with some embodiments of the present disclosure. As shown in the operational example 600, during the first stage of the weighting mechanism 414, the computing system 101 may generate a set of nodes 430 and edges 424 of the class-specific graph representation 410 and/or assign one or more edge weights 428 to up to each of the set of nodes.

In some embodiments, an edge weight 428 is a numerical value assigned to an edge 424 in a class-specific graph representation 410 that quantifies the strength and/or importance of the relationship between two connected nodes 430. The edge weight 428 may comprise a numeric attribute of an edge object in a graph data structure, such as a floating point value, a scalar value, and/or the like that is stored directly with the edge 424, a separate data structure that maps edge identifiers to weight values for more flexible memory management, and/or the like. In some examples, an edge weight 428 may comprise an Optimal Smoother Edge Weight (OSEW) that may be determined based on the co-occurrence patterns of the connected class values within the set of class value combinations associated with an entity identifier along with graph structure characteristics like variability presence in the graph. The computing system 101, for example, may determine an OSEW as a function of the number of class value combinations that contain both connected class values, divided by the total number of combinations that contain either of the two class values.

In some embodiments, the OSEW may be scaled using an optimal multiplier factor (OMF) to balance different intensities of a relationship based on a number of available inputs (e.g., a population density) used to derive the OSEW. The OMF, for example, may comprise a scaling coefficient that is determined as a function of the variability of a class-specific graph representation. For instance, the OMF may comprise a reward and/or penalization multiplication factor that is adjusted based on a statistical attribute of a graph. As examples, the OMF may be based on a variability presence, a minimum and/or maximum value of class value combinations that contain both connected class values and/or the total number of combinations that contain either of the two class values, and/or the like. By way of example, an OMF may be configured to penalize (e.g., a multiplication penalty of 0.8, 0.9) an OSEW associated with a total number of combinations that meet or exceed a maximum threshold (e.g., 1000) and reward (e.g., a multiplication reward of 1.1, 1.2) an OSEW associated with a total number of combinations that is below the maximum threshold (e.g., 1000). In this manner, an OMF may cover the variability of a population in the form of a higher and/or lower value of a combination that connects the two connected nodes 430. The OMF may be applied on an initial (e.g., unscaled) OSEW to generate the OSEW, which may distinguish the edges between them. This approach helps to normalize the weight and reduce bias towards frequently occurring values within a set of input data objects.

FIG. 6B depicts an operational example 650 of a second stage of the weighting mechanism 414 in accordance with some embodiments of the present disclosure. As shown in the operational example 650, during the second stage of the weighting mechanism 414, the computing system 101 may generate a set of nodes 430 and edges 424 of the weighted class-specific graph representation 412 and/or assign one or more node weights 426 to up to each of the set of nodes.

In some embodiments, a node weight 426 is a numerical value assigned to a node 430 in a weighted class-specific graph representation 412 that quantifies the overall importance and/or significance of the corresponding class value within the context of the entity being analyzed. A node weight 426, for example, may comprise a numeric attribute of a node object in a graph data structure, such as a floating point value, a scalar value, and/or the like that is stored directly with the node 430, stored as a separate data structure that maps node identifiers to weight values, allowing for more flexible updates, and/or the like. In some examples, a node weight 426 may comprise an Optimal Smoother Edge Weight (OSEW) that is derived from the edge weights 428 of the edges 424 connected to the node 430. The computing system 101, for example, may determine a node weight by aggregating the edge weights 428 of all edges 424 connected to the node 430. To do so, the computing system 101 may sum the edge weights 428, determine average, maximum, and/or the like. By doing so, the computing system 101 may determine a node weight 426 that captures the cumulative strength of all relationships involving a class value represented by the node 430.

FIG. 7 depicts an operational example 700 of a graph vectorization approach in accordance with some embodiments of the present disclosure. The graph vectorization approach may be implemented by a computing system, such as the computing system 101, to convert a weighted class-specific graph representation 412 to an enriched graph embedding 704 that provides a scaled representation of the semantic and contextual details of the weighted class-specific graph representation 412. For example, to address discrepancy between an amount of data available for different entities within a prediction domain, the graph vectorization approach may comprise a set of stages that incrementally embed, scale, and then aggregate graph attributes of a weighted class-specific graph representation 412. In this manner, the computing system 101 may train a machine learned classifier to leverage relative frequency attributes across a training dataset of variable input sizes (e.g., based on age, history) without biasing entities with relatively less input data. This, in turn, improves the performance of the machine learned classifier with respect to new data entities (e.g., newly detected viruses, new providers within a healthcare system), among other advantages.

In some embodiments, the graph vectorization approach transforms the weighted class-specific graph representation 412 into an enriched graph embedding 704 using a staged approach. For example, in a first stage of the staged approach, the computing system 101 may generate a scaled graph embedding 702 that may be used as an intermediate representation for a subsequent, enriched graph embedding 704.

More particularly, as described herein, the computing system 101 may generate, using a graph model, a graph embedding for up to each node of the weighted class-specific graph representation 412. The first node. In some embodiments, the computing system 101 generates a scaled graph embedding 702 from a graph embedding by applying the node weight to the graph embedding. The computing system 101 may generate a scaled graph embedding 702 for up to each of the graph embeddings based on the node weights corresponding to their respective nodes.

In some embodiments, the scaled graph embedding 702 is a modified version of a graph embedding where the original embedding vector is adjusted by applying a scaling factor (e.g., the OVWM). The scaling factor, for example, may comprise the node weight 426 for a node corresponding to the graph embedding. By doing so, the computing system 101 may generate a scaled graph embedding that incorporates the importance and/or significance of a node, as captured by its node weight 426, into the semantic and/or relational information represented by its graph embedding. In some examples, the computing system 101 may generate the scaled graph embedding by using element-wise multiplication of the original graph embedding vector with a node weight (and/or a derivative value derived from the node weight). For example, a scaling factor may comprise the node weight 426 itself, or it could be a function of the node weight 426, such as a normalization and/or transformation designed to control the range and/or distribution of the scaling. In some examples, the computing system 101 may uniformly apply the scaling factor across all dimensions of a graph embedding to generate the scaled graph embedding 702. By incorporating node weights into the graph embeddings, the scaled graph embeddings 702 may provide more nuanced and/or task-relevant input for downstream machine learning models.

The computing system 101 may generate an enriched graph embedding 704 for up to each of the nodes with weighted class-specific graph representation 412 based on their respective node weights. In some examples, for a up to each node within the weighted class-specific graph representation 412, the computing system 101 may determine a subset of scaled graph embeddings from a set of scaled graph embeddings 702 that respectively correspond to the set of nodes based on the subset of edges connected to the node and concatenate the subset of scaled graph embeddings to form an enriched graph embedding for the node.

In some embodiments, the enriched graph embedding 704 is an enhanced vector representation a node that incorporates information from its local neighborhood in the graph. Specifically, an enriched graph embedding 704 may comprise an aggregated connected node vector that combines scaled graph embeddings 702 for up to each node connected to a particular node, providing a richer representation of the node's context within the graph structure. An enriched graph embedding 704 may be implemented as a computational process that combines multiple vector representations. For example, the computing system 101 may generating scaled graph embeddings 702 for a target node and/or its neighbors, the computing system 101 may determine a subset of the scaled graph embeddings 702 based on the graph structure, and then aggregate determined subset of scaled graph embeddings 702 to form the final enriched representation. The aggregation may comprise concatenation, element-wise summation, and/or any other pooling mechanism.

The enriched graph embeddings 704 serve to capture the characteristics of individual nodes and the structure and/or composition of their local neighborhoods. This may provide valuable contextual information for downstream machine learning tasks that may improve the performance of classification and/or prediction models, such as the machine learned classifier of the present disclosure. By incorporating information from connected nodes, enriched graph embeddings 704 may capture higher-order relationships and/or patterns in the graph that may be obfuscated by individual node representations alone.

In some embodiments, the computing system 101 generates a class-specific vector representation by aggregating the set of enriched graph embeddings 704 respectively corresponding to the set of nodes of the weighted class-specific graph representation 412.

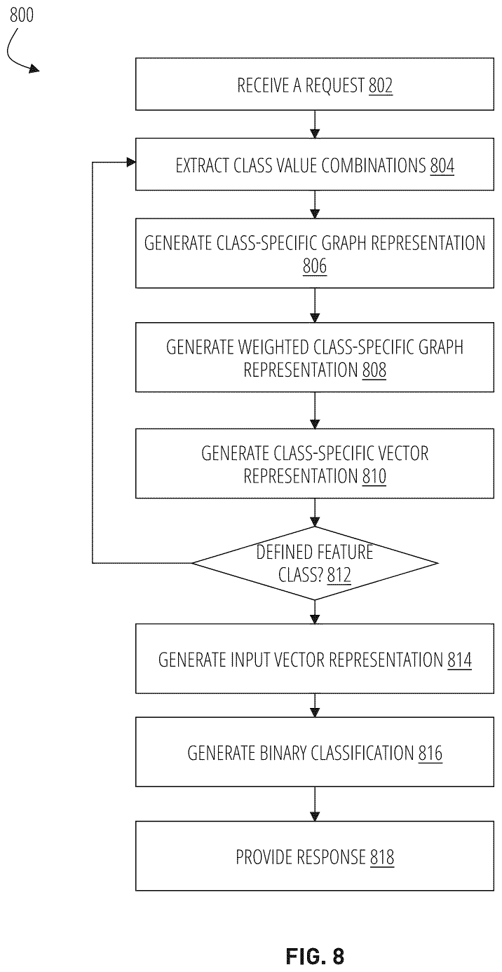

FIG. 8 depicts a flowchart diagram of an example graph-based vectorization and prediction process 800 in accordance with some embodiments of the present disclosure. The flowchart diagram depicts an improved feature engineering approach that leverages graph data structures, scaling factors, and vectorization techniques to generate predictive feature vectors for a machine learned classifier. The process 800 may be implemented by one or more computing devices, entities, and/or systems described herein. For example, via the various steps/operations of the process 800, the computing system 101 may generate contextually and semantically enriched input vector representations for input and training a machine learned classifier. By doing so, the process 800 improves computer functionality by improving both the training efficiency (e.g., in terms of speed) and end performance (e.g., in terms of accuracy) of a machine learned classifiers.

FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

In some embodiments, the process 800 comprises, at operation 802, receiving a request. For example, the computing system 101 may receive a request 402 that comprises entity identifier corresponding to a set of class value combinations. In some examples, the set of class value combinations respectively correspond to a set of input data objects associated with the entity identifier.

In some embodiments, the process 800 comprises, at operation 804, extracting class value combinations for the entity identifier. For example, the computing system 101 may extract a group of class value combinations from an input data object of the set of input data objects 406. The group of class value combinations, for example, may respectively correspond to a set of defined feature classes. For example, a class value combination may comprise a first class value combination of the group of class value combinations that corresponds to a first feature class of the set of defined feature classes.

In some embodiments, the process 800 comprises, at operation 806, generating class-specific graph representation for the entity identifier. For example, the computing system 101 may generate a class-specific graph representation of the entity identifier based on the set of class value combinations. To do so, the computing system 101 may generate a first node corresponding to a first class value of a class value combination of the set of class value combinations, generate a second node corresponding to a second class value of the class value combination, and responsive to the presence of the first class value and the second class value within the class value combination, generate an edge between the first node and the second node.

In some embodiments, the process 800 comprises, at operation 808, generating weighted class-specific graph representations for the entity identifier. For example, the computing system 101 may generate a weighted class-specific graph representation from the class-specific graph representation by assigning an edge weight to the edge based on a relative combination frequency of the first class value and the second class value within the set of class value combinations. In some examples, the computing system 101 assigns a node weight for up to each node based on the edge weight. The node weight, for example, may comprise an aggregation of a subset of edge weights, from a set of edge weights of the weighted class-specific graph representation 412, that is associated with a subset of edges, from a set of edges of the weighted class-specific graph representation 412, connected to a particular node.

In some examples, the computing system 101 may generate, based on the group of class value combinations of up to each of the set of input data objects, a set of weighted class-specific graph representations that respectively correspond to the set of defined feature classes. For example, the class-specific graph representation may comprise a first class-specific graph representation of the set of class-specific graph representations that corresponds to the first feature class.

In some embodiments, the process 800 comprises, at operation 810, generating a class-specific vector representation. For example, the computing system 101 may generate a class-specific vector representation for the entity identifier based on the weighted class-specific graph representation. To do so, the computing system 101 may generate, using a graph model, a set of graph embeddings from the weighted class-specific graph representation. The computing system 101 may generate an enriched graph embedding for up to each of the nodes with weighted class-specific graph representation based on their respective node weights and generate the class-specific vector representation by aggregating the set of enriched graph embeddings respectively corresponding to the set of nodes of the weighted class-specific graph representation.

In some examples, the computing system 101 generates a scaled graph embedding 702 from a graph embedding by applying the node weight to the graph embedding. The computing system 101 may determine a subset of scaled graph embeddings from a set of scaled graph embeddings that respectively correspond to the set of nodes based on the subset of edges connected to the first node and concatenate the subset of scaled graph embeddings to form the enriched graph embedding for the first node.

In some examples, the computing system 101 may generate, based on the set of weighted class-specific graph representations, a set of class-specific vector representations that respectively correspond to the set of defined feature classes. The class-specific vector representation, for example, may comprise a first class-specific vector representation of the set of class-specific vector representations that corresponds to the first feature class.

In some embodiments, the process 800 comprises, at operation 812, detecting whether a class-specific vector representation is generated for up to each of a set of defined feature classes. In the event that a class-specific vector representation exists for up to each of the set of defined feature classes, the process 800 may proceed to operation 814. In addition, or alternatively, if a class-specific vector representation does not exist for at least one of set of defined feature classes, the process 800 may return to operation 804 to perform another class feature engineering iteration for the at least one class.

In some embodiments, the process 800 comprises, at operation 814, generating an input vector representation. For example, the computing system 101 may a set of input vector representations for the entity identifier. In some examples, an input vector representation of the set of input vector representations may comprise a subset of the set of class-specific vector representations that respectively correspond to a subset of the set of defined feature classes. The subset of class-specific vector representations, for example, may be concatenated in accordance with a model-specific vector structure to form the input vector representation.

In some embodiments, the process 800 comprises, at operation 816, generating a binary classification. For example, the computing system 101 may input the class-specific vector representation to a machine learned classifier to receive a binary classification for the entity identifier. In some examples, the machine learned classifier comprises an ensemble classifier with a set of classifier model layers connected to a pooling layer. A classifier model layer of the set of classifier model layers, for example, may be individually trained using a set of labeled training vector representations. In some examples, the pooling layer 504 may comprise a max voting layer. In some examples, a labeled training vector representation of the set of labeled training vector representations may comprise (a) a negative label and/or a positive label and/or (b) a training vector representation that corresponds to a subset of the set of defined feature classes.

In some embodiments, the process 800 comprises, at operation 818, providing a response to the request. For example, the computing system 101 may provide a response to the request based on the binary classification.

Some techniques of the present disclosure enable the generation of action outputs that may be performed to initiate one or more real world actions to achieve real-world effects. The techniques of the present disclosure may be used, applied, and/or otherwise leveraged to handle requests in various circumstances, including clinical detection use cases, computer assessment use cases, among others. In some examples, the response to the requests of the present disclosure may trigger action outputs (e.g., through control instructions) to automate clinical actions, computer performance actions, and/or the like. The action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise, a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

Example 1. A computer-implemented method comprising receiving, by one or more processors, a request that comprises entity identifier corresponding to a set of class value combinations; generating, by the one or more processors, a class-specific graph representation of the entity identifier based on the set of class value combinations by generating a first node corresponding to a first class value of a class value combination of the set of class value combinations, generating a second node corresponding to a second class value of the class value combination, and responsive to a presence of the first class value and the second class value within the class value combination, generating an edge between the first node and the second node; generating, by the one or more processors, a weighted class-specific graph representation from the class-specific graph representation by determining an Optimal Smoother Edge Weight (OSEW) for the edge based on (i) a relative combination frequency of the first class value and the second class value within the set of class value combinations and (ii) an optimal multiplier factor (OMF); generating, by the one or more processors, a class-specific vector representation for the entity identifier based on the weighted class-specific graph representation; generating, by a machine learned classifier using the class-specific vector representation, a classification for the entity identifier; and providing, by the one or more processors, a response to the request based on the classification.

Example 2. The computer-implemented method of example 1, wherein the set of class value combinations respectively correspond to a set of input data objects associated with the entity identifier, and the computer-implemented method further comprises extracting a group of class value combinations from an input data object of the set of input data objects, wherein (a) the group of class value combinations respectively correspond to a set of defined feature classes, and (b) the class value combination is a first class value combination of the group of class value combinations that corresponds to a first feature class of the set of defined feature classes; generating, based on the group of class value combinations of the input data object, a set of weighted class-specific graph representations that respectively correspond to the set of defined feature classes, wherein the weighted class-specific graph representation is a first weighted class-specific graph representation of the set of weighted class-specific graph representations that corresponds to the first feature class; generating, based on the set of weighted class-specific graph representations, a set of class-specific vector representations that respectively correspond to the set of defined feature classes, wherein the class-specific vector representation is a first class-specific vector representation of the set of class-specific vector representations that corresponds to the first feature class; and inputting the set of class-specific vector representations to the machine learned classifier to receive the classification for the entity identifier.

Example 3. The computer-implemented method of example 2, wherein inputting the set of class-specific vector representations to the machine learned classifier comprises generating a set of input vector representations for the entity identifier, wherein an input vector representation of the set of input vector representations comprises a subset of the set of class-specific vector representations with optimal vector weight multiplier (OVWM) that respectively correspond to a subset of the set of defined feature classes; and inputting the set of input vector representations to the machine learned classifier.

Example 4. The computer-implemented method of example 3, wherein the subset of class-specific vector representations is concatenated in accordance with a model-specific vector structure to form the input vector representation.

Example 5. The computer-implemented method of examples 3 or 4, wherein the machine learned classifier comprises an ensemble classifier with a set of classifier model layers connected to a pooling layer, and a classifier model layer of the set of classifier model layers is individually trained using a set of labeled training vector representations.

Example 6. The computer-implemented method of example 5, wherein the pooling layer comprises a max voting layer.

Example 7. The computer-implemented method of examples 5 or 6, wherein a labeled training vector representation of the set of labeled training vector representations comprises (a) a negative label or a positive label and (b) a training vector representation that corresponds to a subset of the set of defined feature classes.

Example 8. The computer-implemented method of any of the preceding examples, wherein generating the weighted class-specific graph representation from the class-specific graph representation comprises determining an optimal vector weight multiplier (OVWM) for the first node based on the OSEW, wherein the OVWM comprises an aggregation of a subset of OSEWs from a set of OSEWs of the weighted class-specific graph representation that is associated with a subset of edges from a set of edges of the weighted class-specific graph representation that is connected to the first node.

Example 9. The computer-implemented method of example 8, wherein generating the class-specific vector representation for the entity identifier based on the weighted class-specific graph representation comprises generating, using a graph model, a graph embedding of the first node; generating an enriched graph embedding for the first node based on the OVWM; and generating the class-specific vector representation by aggregating the enriched graph embedding with a set of enriched graph embeddings respectively corresponding to a set of nodes of the weighted class-specific graph representation.

Example 10. The computer-implemented method of example 9, wherein generating the enriched graph embedding for the first node comprises generating a scaled graph embedding from the graph embedding by multiplying the graph embedding by the OVWM; determining a subset of scaled graph embeddings from a set of scaled graph embeddings that respectively correspond to the set of nodes based on the subset of edges connected to the first node; and concatenating the subset of scaled graph embeddings to form the enriched graph embedding for the first node.

Example 11. A system comprising one or more processors; and one or more memories storing processor-executable instructions that, when executed by the one or more processors, cause the one or more processors to perform operations comprising receiving a request that comprises entity identifier corresponding to a set of class value combinations; generating a class-specific graph representation of the entity identifier based on the set of class value combinations by generating a first node corresponding to a first class value of a class value combination of the set of class value combinations, generating a second node corresponding to a second class value of the class value combination, and responsive to a presence of the first class value and the second class value within the class value combination, generating an edge between the first node and the second node; generating a weighted class-specific graph representation from the class-specific graph representation by determining an Optimal Smoother Edge Weight (OSEW) for the edge based on (i) a relative combination frequency of the first class value and the second class value within the set of class value combinations and (ii) an optimal multiplier factor (OMF); generating a class-specific vector representation for the entity identifier based on the weighted class-specific graph representation; generating, by a machine learned classifier using the class-specific vector representation, a classification for the entity identifier; and providing a response to the request based on the classification.

Example 12. The system of example 11, wherein the set of class value combinations respectively correspond to a set of input data objects associated with the entity identifier, and the operations further comprise extracting a group of class value combinations from an input data object of the set of input data objects, wherein (a) the group of class value combinations respectively correspond to a set of defined feature classes, and (b) the class value combination is a first class value combination of the group of class value combinations that corresponds to a first feature class of the set of defined feature classes; generating, based on the group of class value combinations of the input data object, a set of weighted class-specific graph representations that respectively correspond to the set of defined feature classes, wherein the weighted class-specific graph representation is a first weighted class-specific graph representation of the set of weighted class-specific graph representations that corresponds to the first feature class; generating, based on the set of weighted class-specific graph representations, a set of class-specific vector representations that respectively correspond to the set of defined feature classes, wherein the class-specific vector representation is a first class-specific vector representation of the set of class-specific vector representations that corresponds to the first feature class; and inputting the set of class-specific vector representations to the machine learned classifier to receive the classification for the entity identifier.

Example 13. The system of example 12, wherein inputting the set of class-specific vector representations to the machine learned classifier comprises generating a set of input vector representations for the entity identifier, wherein an input vector representation of the set of input vector representations comprises a subset of the set of class-specific vector representations with optimal vector weight multiplier (OVWM) that respectively correspond to a subset of the set of defined feature classes; and inputting the set of input vector representations to the machine learned classifier.

Example 14. The system of example 13, wherein the subset of class-specific vector representations is concatenated in accordance with a model-specific vector structure to form the input vector representation.

Example 15. The system of examples 13 or 14, wherein the machine learned classifier comprises an ensemble classifier with a set of classifier model layers connected to a pooling layer, and a classifier model layer of the set of classifier model layers is individually trained using a set of labeled training vector representations.

Example 16. The system of example 15, wherein the pooling layer comprises a max voting layer.

Example 17. One or more non-transitory computer-readable media storing processor-executable instructions that, when executed by one or more processors, cause the one or more processors to perform operations comprising receiving a request that comprises entity identifier corresponding to a set of class value combinations; generating a class-specific graph representation of the entity identifier based on the set of class value combinations by generating a first node corresponding to a first class value of a class value combination of the set of class value combinations, generating a second node corresponding to a second class value of the class value combination, and responsive to a presence of the first class value and the second class value within the class value combination, generating an edge between the first node and the second node; generating a weighted class-specific graph representation from the class-specific graph representation by determining an Optimal Smoother Edge Weight (OSEW) for the edge based on (i) a relative combination frequency of the first class value and the second class value within the set of class value combinations and (ii) an optimal multiplier factor (OMF); generating a class-specific vector representation for the entity identifier based on the weighted class-specific graph representation; generating, by a machine learned classifier using the class-specific vector representation, a classification for the entity identifier; and providing a response to the request based on the classification.

Example 18. The one or more non-transitory computer-readable media of example 17, wherein generating the weighted class-specific graph representation from the class-specific graph representation comprises determining an optimal vector weight multiplier (OVWM) for the first node based on the OSEW, wherein the OVWM comprises an aggregation of a subset of OSEWs from a set of OSEWs of the weighted class-specific graph representation that is associated with a subset of edges from a set of edges of the weighted class-specific graph representation that is connected to the first node.

Example 19. The one or more non-transitory computer-readable media of example 18, wherein generating the class-specific vector representation for the entity identifier based on the weighted class-specific graph representation comprises generating, using a graph model, a graph embedding of the first node; generating an enriched graph embedding for the first node based on the node weight; and generating the class-specific vector representation by aggregating the enriched graph embedding with a set of enriched graph embeddings respectively corresponding to a set of nodes of the weighted class-specific graph representation.

Example 20. The one or more non-transitory computer-readable media of example 19, wherein generating the enriched graph embedding for the first node comprises generating a scaled graph embedding from the graph embedding by applying the node weight to the graph embedding; determining a subset of scaled graph embeddings from a set of scaled graph embeddings that respectively correspond to the set of nodes based on the subset of edges connected to the first node; and concatenating the subset of scaled graph embeddings to form the enriched graph embedding for the first node.

Example 21. The computer-implemented method of example 1, wherein the method further comprises training the machine learned classifier.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The computing system of example 11, wherein the one or more processors are further configured to train the machine learned classifier.

Example 25. The computing system of example 24, wherein the one or more processors are comprised in a first computing entity; and the machine learned classifier is trained by one or more other processors comprised in a second computing entity.

Example 26. The one or more non-transitory computer-readable storage media of example 19, wherein the instructions further cause the one or more processors to train the machine learned classifier.

Example 27. The one or more non-transitory computer-readable storage media of example 26, wherein the one or more processors are comprised in a first computing entity; and the machine learned classifier is trained by one or more other processors comprised in a second computing entity.

What is claimed is:

1. A computer-implemented method comprising:
receiving, by one or more processors, a request that comprises entity identifier corresponding to a set of class value combinations;
generating, by the one or more processors, a class-specific graph representation of the entity identifier based on the set of class value combinations by:
generating a first node corresponding to a first class value of a class value combination of the set of class value combinations,
generating a second node corresponding to a second class value of the class value combination, and
responsive to a presence of the first class value and the second class value within the class value combination, generating an edge between the first node and the second node;
generating, by the one or more processors, a weighted class-specific graph representation from the class-specific graph representation by determining an Optimal Smoother Edge Weight (OSEW) for the edge based on (i) a relative combination frequency of the first class value and the second class value within the set of class value combinations and (ii) an optimal multiplier factor (OMF);
generating, by the one or more processors, a class-specific vector representation for the entity identifier based on the weighted class-specific graph representation;
generating, by a machine learned classifier using the class-specific vector representation, a classification for the entity identifier; and
providing, by the one or more processors, a response to the request based on the classification.

2. The computer-implemented method of claim 1, wherein the set of class value combinations respectively correspond to a set of input data objects associated with the entity identifier, and the computer-implemented method further comprises:
extracting a group of class value combinations from an input data object of the set of input data objects, wherein (a) the group of class value combinations respectively correspond to a set of defined feature classes, and (b) the class value combination is a first class value combination of the group of class value combinations that corresponds to a first feature class of the set of defined feature classes;
generating, based on the group of class value combinations of the input data object, a set of weighted class-specific graph representations that respectively correspond to the set of defined feature classes, wherein the weighted class-specific graph representation is a first weighted class-specific graph representation of the set of weighted class-specific graph representations that corresponds to the first feature class;
generating, based on the set of weighted class-specific graph representations, a set of class-specific vector representations that respectively correspond to the set of defined feature classes, wherein the class-specific vector representation is a first class-specific vector representation of the set of class-specific vector representations that corresponds to the first feature class; and
inputting the set of class-specific vector representations to the machine learned classifier to receive the classification for the entity identifier.

3. The computer-implemented method of claim 2, wherein inputting the set of class-specific vector representations to the machine learned classifier comprises:
generating a set of input vector representations for the entity identifier, wherein an input vector representation of the set of input vector representations comprises a subset of the set of class-specific vector representations with optimal vector weight multiplier (OVWM) that respectively correspond to a subset of the set of defined feature classes; and
inputting the set of input vector representations to the machine learned classifier.

4. The computer-implemented method of claim 3, wherein the subset of class-specific vector representations is concatenated in accordance with a model-specific vector structure to form the input vector representation.

5. The computer-implemented method of claim 3, wherein the machine learned classifier comprises an ensemble classifier with a set of classifier model layers connected to a pooling layer, and a classifier model layer of the set of classifier model layers is individually trained using a set of labeled training vector representations.

6. The computer-implemented method of claim 5, wherein the pooling layer comprises a max voting layer.

7. The computer-implemented method of claim 5, wherein a labeled training vector representation of the set of labeled training vector representations comprises (a) a negative label or a positive label and (b) a training vector representation that corresponds to a subset of the set of defined feature classes.

8. The computer-implemented method of claim 1, wherein generating the weighted class-specific graph representation from the class-specific graph representation comprises determining an optimal vector weight multiplier (OVWM) for the first node based on the OSEW, wherein the OVWM comprises an aggregation of a subset of OSEWs from a set of OSEWs of the weighted class-specific graph representation that is associated with a subset of edges from a set of edges of the weighted class-specific graph representation that is connected to the first node.

9. The computer-implemented method of claim 8, wherein generating the class-specific vector representation for the entity identifier based on the weighted class-specific graph representation comprises:
generating, using a graph model, a graph embedding of the first node;
generating an enriched graph embedding for the first node based on the OVWM; and
generating the class-specific vector representation by aggregating the enriched graph embedding with a set of enriched graph embeddings respectively corresponding to a set of nodes of the weighted class-specific graph representation.

10. The computer-implemented method of claim 9, wherein generating the enriched graph embedding for the first node comprises:
generating a scaled graph embedding from the graph embedding by multiplying the graph embedding by the OVWM;
determining a subset of scaled graph embeddings from a set of scaled graph embeddings that respectively correspond to the set of nodes based on the subset of edges connected to the first node; and
concatenating the subset of scaled graph embeddings to form the enriched graph embedding for the first node.

11. A system comprising:
one or more processors; and
one or more memories storing processor-executable instructions that, when executed by the one or more processors, cause the one or more processors to perform operations comprising:
receiving a request that comprises entity identifier corresponding to a set of class value combinations;
generating a class-specific graph representation of the entity identifier based on the set of class value combinations by:
generating a first node corresponding to a first class value of a class value combination of the set of class value combinations,
generating a second node corresponding to a second class value of the class value combination, and
responsive to a presence of the first class value and the second class value within the class value combination, generating an edge between the first node and the second node;
generating a weighted class-specific graph representation from the class-specific graph representation by determining an Optimal Smoother Edge Weight (OSEW) for the edge based on (i) a relative combination frequency of the first class value and the second class value within the set of class value combinations and (ii) an optimal multiplier factor (OMF);
generating a class-specific vector representation for the entity identifier based on the weighted class-specific graph representation;
generating, by a machine learned classifier using the class-specific vector representation, a classification for the entity identifier; and
providing a response to the request based on the classification.

12. The system of claim 11, wherein the set of class value combinations respectively correspond to a set of input data objects associated with the entity identifier, and the operations further comprise:
extracting a group of class value combinations from an input data object of the set of input data objects, wherein (a) the group of class value combinations respectively correspond to a set of defined feature classes, and (b) the class value combination is a first class value combination of the group of class value combinations that corresponds to a first feature class of the set of defined feature classes;
generating, based on the group of class value combinations of the input data object, a set of weighted class-specific graph representations that respectively correspond to the set of defined feature classes, wherein the weighted class-specific graph representation is a first weighted class-specific graph representation of the set of weighted class-specific graph representations that corresponds to the first feature class;
generating, based on the set of weighted class-specific graph representations, a set of class-specific vector representations that respectively correspond to the set of defined feature classes, wherein the class-specific vector representation is a first class-specific vector representation of the set of class-specific vector representations that corresponds to the first feature class; and
inputting the set of class-specific vector representations to the machine learned classifier to receive the classification for the entity identifier.

13. The system of claim 12, wherein inputting the set of class-specific vector representations to the machine learned classifier comprises:
generating a set of input vector representations for the entity identifier, wherein an input vector representation of the set of input vector representations comprises a subset of the set of class-specific vector representations with optimal vector weight multiplier (OVWM) that respectively correspond to a subset of the set of defined feature classes; and
inputting the set of input vector representations to the machine learned classifier.

14. The system of claim 13, wherein the subset of class-specific vector representations is concatenated in accordance with a model-specific vector structure to form the input vector representation.

15. The system of claim 13, wherein the machine learned classifier comprises an ensemble classifier with a set of classifier model layers connected to a pooling layer, and a classifier model layer of the set of classifier model layers is individually trained using a set of labeled training vector representations.

16. The system of claim 15, wherein the pooling layer comprises a max voting layer.

17. One or more non-transitory computer-readable media storing processor-executable instructions that, when executed by one or more processors, cause the one or more processors to perform operations comprising:
receiving a request that comprises entity identifier corresponding to a set of class value combinations;
generating a class-specific graph representation of the entity identifier based on the set of class value combinations by:
generating a first node corresponding to a first class value of a class value combination of the set of class value combinations,
generating a second node corresponding to a second class value of the class value combination, and
responsive to a presence of the first class value and the second class value within the class value combination, generating an edge between the first node and the second node;
generating a weighted class-specific graph representation from the class-specific graph representation by determining an Optimal Smoother Edge Weight (OSEW) for the edge based on (i) a relative combination frequency of the first class value and the second class value within the set of class value combinations and (ii) an optimal multiplier factor (OMF);
generating a class-specific vector representation for the entity identifier based on the weighted class-specific graph representation;
generating, by a machine learned classifier using the class-specific vector representation, a classification for the entity identifier; and
providing a response to the request based on the classification.

18. The one or more non-transitory computer-readable media of claim 17, wherein generating the weighted class-specific graph representation from the class-specific graph representation comprises determining an optimal vector weight multiplier (OVWM) for the first node based on the OSEW, wherein the OVWM comprises an aggregation of a subset of OSEWs from a set of OSEWs of the weighted class-specific graph representation that is associated with a subset of edges from a set of edges of the weighted class-specific graph representation that is connected to the first node.

19. The one or more non-transitory computer-readable media of claim 18, wherein generating the class-specific vector representation for the entity identifier based on the weighted class-specific graph representation comprises:
generating, using a graph model, a graph embedding of the first node;
generating an enriched graph embedding for the first node based on the node weight; and
generating the class-specific vector representation by aggregating the enriched graph embedding with a set of enriched graph embeddings respectively corresponding to a set of nodes of the weighted class-specific graph representation.

20. The one or more non-transitory computer-readable media of claim 19, wherein generating the enriched graph embedding for the first node comprises:
generating a scaled graph embedding from the graph embedding by applying the node weight to the graph embedding;
determining a subset of scaled graph embeddings from a set of scaled graph embeddings that respectively correspond to the set of nodes based on the subset of edges connected to the first node; and
concatenating the subset of scaled graph embeddings to form the enriched graph embedding for the first node.
